(19) United States
(12) Patent Application Publication
(10) Pub. No.: US 2014/0324488 A1
(43) Pub. Date: Oct. 30, 2014

(54) NO LINE NO WAITING MOBILE SOFTWARE

(71) Applicant: Steven Boccelli, North Reading, MA (US)

(72) Inventor: Steven Boccelli, North Reading, MA (US)

(21) Appl. No.: 14/261,419

(22) Filed: Apr. 24, 2014

Related U.S. Application Data
(60) Provisional application No. 61/815,491, filed on Apr. 24, 2013.

(51) Int. Cl. G06Q 10/02

(52) U.S. Cl. CPC G06Q 10/02
USPC 705/5

(57) ABSTRACT

A new system of managing lines at walk-in venues that allow patrons to enter a line remotely over a cellular network, without having to first travel to the walk-in venue and without having to remain in the walk-in venue. The system can provide confirmation to the walk-in venue that customers or patrons received the next in line notifications.

### CROSS REFERENCE TO RELATED APPLICATION

This application claims the benefit of U.S. Provisional Patent Application No. 61/815,491, filed on Apr. 24, 2013, the contents of which are incorporated herein by reference.

### FIELD OF THE INVENTION

The field of the invention relates to method and system for determining and managing line positions at a point of access to a walk-in venue or a service provider.

### BACKGROUND OF INVENTION

Crowded businesses and government offices that service walk-in patrons or customers with little or no advance notice often develop long waiting lines. These walk-in venues often cannot allocate enough resources to prevent these long waiting lines.

Waiting in these lines is a common, frustrating, and time-wasting experience for most people. It can be difficult for people to schedule and plan for these lines as most walk-in venues are ordered on a first-come, first-served basis.

These long waiting lines result in lost productivity for the patrons or customers, as well as lost business or revenue for the walk-in venues. State, local, and federal government may lose opportunities to collect taxes in a timely manner, or collect fees for government services such as the post office or state college registration offices. Potential customers may leave crowded restaurants. Amusement parks may not sell as much food or souvenirs to customers that are waiting in line for rides.

Most walk-in facilities have designated waiting areas. These waiting areas are usually unappealing and uncomfortable to people. Some people may experience severe discomfort or anxiety, such as agoraphobia (an abnormal fear public, open, or crowded places) or mysophobia (an abnormal fear of germs, contamination, or dirt). People that suffer higher levels of discomfort and anxiety may reduce or eliminate their use of the walk-in venues. This can mean even further lost revenue.

These waiting areas are also spaces that cost walk-in venues money to purchase, lease, and maintain. Most walk-in venues spend a lot of resources cleaning and updating waiting areas as an unclean or damaged waiting area will leave a bad impression on customers.

Furthermore, crowded designated waiting areas increase the spread of airborne contagions, especially in waiting areas filled with the sick and ailing, such as doctor's offices. Since these contagions spread more rapidly when people are in close proximity, it would be beneficial to eliminate or reduce times spent in health-care facilities waiting rooms.

Some walk-in venues provide special designated waiting areas for recurring customers, VIPs, or customers with walk-in venue memberships. These special lines can cause two sets of lines that are confusing to customers. These two sets of lines can also build resentment among potential customers.

Several systems for managing lines do currently exist, but these systems have high costs of purchase, implementation, training, and maintenance. In addition, a customer or patron must travel to the walk-in venue and remain in the local area to use these managing systems. Furthermore, none of these systems provide the walk-in facility with information on their customers, and means to interact with customers or to verify they actually received any next in line notification.

For example, intercom paging systems allow for customer names to be called out over one or more loud speakers to a crowd of waiting customers. These systems are often not reliably heard by customers, and produce a loud, annoying waiting area for other customers. Electronic “Take a number” systems provide each customer with a printed ticket showing his or her place in line. Elevated screens display the number currently being served to designated waiting area. These systems are also often not reliably seen by customers. Specialized paging systems provide waiting customers with specialized pagers that activate when the customer is next in line. These pagers have limited distances of operation and are very expensive. Furthermore, the pagers must always be charged, replaced if damaged, and maintained in a large enough inventories for many waiting customers.

Thus, a new system of managing lines at walk-in venues is needed. This system should allow customers or walk-in patrons to enter a line at a walk-in venue, without having to first travel to the walk-in venue and without having to remain in the walk-in venue. Less customers or patrons at the walk-in venue will reduce the sizes of designated waiting areas—allowing walk-in venues to lease or purchase less space (or more efficiently use their current space). Allowing customers to plan wait times will allow them to more effectively schedule. This system should avoid expensive specialized equipment to prevent the high costs of purchase and maintenance. Finally, this system can provide confirmation to the walk-in venue that customers or patrons received the next in line notifications.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting

The subject invention discloses a mobile software application executable on a mobile cellular device for assigning and managing a line position for a walk-in service provider with a first come, first serve active line, the mobile software application comprising: at least one first graphical user interface screen with at least one first data entry field to allow a user to search for a computer server of the walk-in service provider over a cellular network, wherein the user selects the computer server, further wherein the computing server maintains a plurality of substantially real-time line positions of waiting patrons on a line position database and is configured to receive line reservation requests over the cellular network; at least one second graphical user interface screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the mobile cellular device over the cellular network.

The subject invention discloses a mobile software application executable on a smartphone for designating and administering a line position for a service provider with an active line in which patrons are served in the order they arrived at the service provider, the mobile software application comprising: at least one first graphical user interface screen with at least one first data entry field to allow a user to search for a computer server of the walk-in service provider over a cellular network, wherein the user selects the computer server, further wherein the computing server maintains a plurality of substantially real-time line positions of waiting patrons on a line position database and is configured to receive line reservation requests over the cellular network; at least one second graphical user interface screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the smartphone over the cellular network.

The subject invention discloses a mobile software application executable on a mobile cellular device for assigning and managing a line position for a walk-in service provider with a first come, first serve active line, the mobile software application comprising: at least one search graphical user interface display screen with at least one first data entry field on the mobile cellular device to allow a user to search for a computer server of the walk-in service provider over a cellular network; at least one search results graphical user interface display screen with at least one selection button, wherein the user selects the computer server from the search results graphical user interface display screen with the selection button, further wherein the computing server maintains a plurality of substantially real-time line positions of waiting patrons on a line position database and is configured to receive line reservation requests over the cellular network; at least one line request graphical user interface display screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the mobile cellular device over the cellular network; and at least one line position graphical user interface display screen that displays the real-time substantially real-time line position on the mobile cellular device.

The subject invention discloses a mobile software application executable on a mobile cellular device for assigning and managing a line position for a walk-in service provider with a first come, first serve active line, the mobile software application comprising: at least one search query graphical user interface screen with at least one first data entry field on the mobile cellular device to allow a user to search for a walk-in service provider over a cellular network; at least one search results graphical user interface screen with at least one first selection button, wherein the user selects the walk-in service provider from the search results graphical user interface screen with the first selection button, further wherein the walk-in service provider has a computing server that maintains a plurality of substantially real-time line positions of waiting patrons on a line position database and is configured to receive software instructions over the cellular network, wherein the computing server transmits at least one welcome graphical user interface screen to the mobile cellular device; at least one second selection button and at least one third selection button on the welcome graphical user interface screen, wherein upon selection of the second selection button by the user, the computing server transmits a real-time position currently being served at the walk-in service provider to the mobile cellular device, further wherein upon selection of the third selection button by the user, the computing server determines the next available substantially real-time line position from the plurality of substantially real-time line positions of waiting patrons, assigns the user to the next available substantially real-time line position to the user, and transmits this line position to the mobile cellular device over the cellular network; and at least one line position graphical user interface screen that displays the real-time substantially real-time line position on the mobile cellular device, wherein the computer server transmits all updates to the user's substantially real-time line position in the active line to the line position graphical user interface screen.

The subject invention discloses a system for assigning and managing a line position for a walk-in service provider with a first come, first serve active line, the system comprising: a computing server comprising executable software; a line position database on the computing server, wherein the computing server maintains a plurality of substantially real-time line positions of waiting patrons on the database, further wherein the computer server is configured to receive line reservation requests over a cellular network; a software application executable on a mobile cellular device, wherein a user requests a substantially real-time line position over the cellular network from the computing server, further wherein the computer server determines the next available substantially real-time line position from the plurality of substantially real-time line positions of waiting patrons, assigns the next available substantially real-time line position to the user, and transmits this position to the user over the cellular network.

The subject invention discloses a system for designating and administering a line position for a service provider with an active line in which patrons are served in the order they arrived at the service provider, the system comprising: a computing server comprising executable software; a line position database on the computing server, wherein the computing server administers a plurality of substantially real-time line positions of waiting patrons on the database, further wherein the computer server is configured to receive line reservation requests over a cellular network; a software application executable on a smartphone, wherein a user requests a substantially real-time line position over the cellular network from the computing server, further wherein the computer server determines the next available substantially real-time line position from the plurality of substantially real-time line positions of waiting patrons, designates the next available substantially real-time line position to the user, and transmits this position to the user over the cellular network.

The subject invention discloses a system for reducing patron waiting times for a service provider with an active line in which patrons are served in the order they arrived at the provider, the system comprising: a computing server comprising executable software; a line position database on the computing server, wherein the computing server administers a plurality of substantially real-time line positions of waiting patrons on the database, further wherein the computer server is configured to receive line position requests over a cellular network; a software application executable on a mobile cellular device, wherein a user requests a substantially real-time line position over the cellular network from the computing server, further wherein the computer server determines the next available substantially real-time line position from the plurality of substantially real-time line positions of waiting patrons, designates the next available substantially real-time line position to the user, and transmits this position to the user over the cellular network.

The subject invention discloses a mobile software application executable on a mobile cellular device for assigning and managing a line position for a walk-in venue with a first come, first serve active line, the mobile software application comprising: at least one first graphical user interface screen with at least one first data entry field to allow a user to search for a computer server of the walk-in venue over a cellular network, wherein the user selects the computer server, further wherein the computing server maintains a plurality of substantially real-time line positions of waiting patrons on a line position database and is configured to receive line reservation requests over the cellular network; at least one second graphical user interface screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the mobile cellular device over the cellular network.

The subject invention discloses a mobile software application executable on a smartphone for designating and administering a line position for a venue with an active line in which patrons are served in the order they arrived at the venue, the mobile software application comprising: at least one first graphical user interface screen with at least one first data entry field to allow a user to search for a computer server of the walk-in venue over a cellular network, wherein the user selects the computer server, further wherein the computing server maintains a plurality of substantially real-time line positions of waiting patrons on a line position database and is configured to receive line reservation requests over the cellular network; at least one second graphical user interface screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the smartphone over the cellular network.

The subject invention discloses a mobile software application executable on a mobile cellular device for assigning and managing a line position for a walk-in venue with a first come, first serve active line, the mobile software application comprising: at least one search graphical user interface display screen with at least one first data entry field on the mobile cellular device to allow a user to search for a computer server of the walk-in venue over a cellular network; at least one search results graphical user interface display screen with at least one selection button, wherein the user selects the computer server from the search results graphical user interface display screen with the selection button, further wherein the computing server maintains a plurality of substantially real-time line positions of waiting patrons on a line position database and is configured to receive line reservation requests over the cellular network; at least one line request graphical user interface display screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the mobile cellular device over the cellular network; and at least one line position graphical user interface display screen that displays the real-time substantially real-time line position on the mobile cellular device.

The subject invention discloses a mobile software application executable on a mobile cellular device for assigning and managing a line position for a walk-in venue with a first come, first serve active line, the mobile software application comprising: at least one search query graphical user interface screen with at least one first data entry field on the mobile cellular device to allow a user to search for a walk-in venue over a cellular network; at least one search results graphical user interface screen with at least one first selection button, wherein the user selects the walk-in venue from the search results graphical user interface screen with the first selection button, further wherein the walk-in venue has a computing server that maintains a plurality of substantially real-time line positions of waiting patrons on a line position database and is configured to receive software instructions over the cellular network, wherein the computing server transmits at least one welcome graphical user interface screen to the mobile cellular device; at least one second selection button and at least one third selection button on the welcome graphical user interface screen, wherein upon selection of the second selection button by the user, the computing server transmits a real-time position currently being served at the walk-in venue to the mobile cellular device, further wherein upon selection of the third selection button by the user, the computing server determines the next available substantially real-time line position from the plurality of substantially real-time line positions of waiting patrons, assigns the user to the next available substantially real-time line position to the user, and transmits this line position to the mobile cellular device over the cellular network; and at least one line position graphical user interface screen that displays the real-time substantially real-time line position on the mobile cellular device, wherein the computer server transmits all updates to the user's substantially real-time line position in the active line to the line position graphical user interface screen.

The subject invention discloses a system for assigning and managing a line position for a walk-in venue with a first come, first serve active line, the system comprising: a computing server comprising executable software; a line position database on the computing server, wherein the computing server maintains a plurality of substantially real-time line positions of waiting patrons on the database, further wherein the computer server is configured to receive line reservation requests over a cellular network; a software application executable on a mobile cellular device, wherein a user requests a substantially real-time line position over the cellular network from the computing server, further wherein the computer server determines the next available substantially real-time line position from the plurality of substantially real-time line positions of waiting patrons, assigns the next available substantially real-time line position to the user, and transmits this position to the user over the cellular network.

The subject invention discloses a system for designating and administering a line position for a venue with an active line in which patrons are served in the order they arrived at the venue, the system comprising: a computing server comprising executable software; a line position database on the computing server, wherein the computing server administers a plurality of substantially real-time line positions of waiting patrons on the database, further wherein the computer server is configured to receive line reservation requests over a cellular network; a software application executable on a smartphone, wherein a user requests a substantially real-time line position over the cellular network from the computing server, further wherein the computer server determines the next available substantially real-time line position from the plurality of substantially real-time line positions of waiting patrons, designates the next available substantially real-time line position to the user, and transmits this position to the user over the cellular network.

The subject invention discloses a system for reducing patron waiting times for a venue with an active line in which patrons are served in the order they arrived at the provider, the system comprising: a computing server comprising executable software; a line position database on the computing server, wherein the computing server administers a plurality of substantially real-time line positions of waiting patrons on the database, further wherein the computer server is configured to receive line position requests over a cellular network; a software application executable on a mobile cellular device, wherein a user requests a substantially real-time line position over the cellular network from the computing server, further wherein the computer server determines the next available substantially real-time line position from the plurality of substantially real-time line positions of waiting patrons, designates the next available substantially real-time line position to the user, and transmits this position to the user over the cellular network.

The subject invention discloses a mobile software application executable on a mobile cellular device for assigning and managing a line position for a walk-in government facility with a first come, first serve active line, the mobile software application comprising: at least one first graphical user interface screen with at least one first data entry field to allow a user to search for a computer server of the walk-in government facility over a cellular network, wherein the user selects the computer server, further wherein the computing server maintains a plurality of substantially real-time line positions of waiting patrons on a line position database and is configured to receive line reservation requests over the cellular network; at least one second graphical user interface screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the mobile cellular device over the cellular network.

The subject invention discloses a mobile software application executable on a smartphone for designating and administering a line position for a government facility with an active line in which patrons are served in the order they arrived at the government facility, the mobile software application comprising: at least one first graphical user interface screen with at least one first data entry field to allow a user to search for a computer server of the walk-in government facility over a cellular network, wherein the user selects the computer server, further wherein the computing server maintains a plurality of substantially real-time line positions of waiting patrons on a line position database and is configured to receive line reservation requests over the cellular network; at least one second graphical user interface screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the smartphone over the cellular network.

The subject invention discloses a mobile software application executable on a mobile cellular device for assigning and managing a line position for a walk-in government facility with a first come, first serve active line, the mobile software application comprising: at least one search graphical user interface display screen with at least one first data entry field on the mobile cellular device to allow a user to search for a computer server of the walk-in government facility over a cellular network; at least one search results graphical user interface display screen with at least one selection button, wherein the user selects the computer server from the search results graphical user interface display screen with the selection button, further wherein the computing server maintains a plurality of substantially real-time line positions of waiting patrons on a line position database and is configured to receive line reservation requests over the cellular network; at least one line request graphical user interface display screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the mobile cellular device over the cellular network; and at least one line position graphical user interface display screen that displays the real-time substantially real-time line position on the mobile cellular device.

The subject invention discloses a mobile software application executable on a mobile cellular device for assigning and managing a line position for a walk-in government facility with a first come, first serve active line, the mobile software application comprising: at least one search query graphical user interface screen with at least one first data entry field on the mobile cellular device to allow a user to search for a walk-in government facility over a cellular network; at least one search results graphical user interface screen with at least one first selection button, wherein the user selects the walk-in government facility from the search results graphical user interface screen with the first selection button, further wherein the walk-in government facility has a computing server that maintains a plurality of substantially real-time line positions of waiting patrons on a line position database and is configured to receive software instructions over the cellular network, wherein the computing server transmits at least one welcome graphical user interface screen to the mobile cellular device; at least one second selection button and at least one third selection button on the welcome graphical user interface screen, wherein upon selection of the second selection button by the user, the computing server transmits a real-time position currently being served at the walk-in government facility to the mobile cellular device, further wherein upon selection of the third selection button by the user, the computing server determines the next available substantially real-time line position from the plurality of substantially real-time line positions of waiting patrons, assigns the user to the next available substantially real-time line position to the user, and transmits this line position to the mobile cellular device over the cellular network; and at least one line position graphical user interface screen that displays the real-time substantially real-time line position on the mobile cellular device, wherein the computer server transmits all updates to the user's substantially real-time line position in the active line to the line position graphical user interface screen.

The subject invention discloses a system for assigning and managing a line position for a walk-in government facility with a first come, first serve active line, the system comprising: a computing server comprising executable software; a line position database on the computing server, wherein the computing server maintains a plurality of substantially real-time line positions of waiting patrons on the database, further wherein the computer server is configured to receive line reservation requests over a cellular network; a software application executable on a mobile cellular device, wherein a user requests a substantially real-time line position over the cellular network from the computing server, further wherein the computer server determines the next available substantially real-time line position from the plurality of substantially real-time line positions of waiting patrons, assigns the next available substantially real-time line position to the user, and transmits this position to the user over the cellular network.

The subject invention discloses a system for designating and administering a line position for a government facility with an active line in which patrons are served in the order they arrived at the government facility, the system comprising: a computing server comprising executable software; a line position database on the computing server, wherein the computing server administers a plurality of substantially real-time line positions of waiting patrons on the database, further wherein the computer server is configured to receive line reservation requests over a cellular network; a software application executable on a smartphone, wherein a user requests a substantially real-time line position over the cellular network from the computing server, further wherein the computer server determines the next available substantially real-time line position from the plurality of substantially real-time line positions of waiting patrons, designates the next available substantially real-time line position to the user, and transmits this position to the user over the cellular network.

The subject invention discloses a system for reducing patron waiting times for a government facility with an active line in which patrons are served in the order they arrived at the provider, the system comprising: a computing server comprising executable software; a line position database on the computing server, wherein the computing server administers a plurality of substantially real-time line positions of waiting patrons on the database, further wherein the computer server is configured to receive line position requests over a cellular network; a software application executable on a mobile cellular device, wherein a user requests a substantially real-time line position over the cellular network from the computing server, further wherein the computer server determines the next available substantially real-time line position from the plurality of substantially real-time line positions of waiting patrons, designates the next available substantially real-time line position to the user, and transmits this position to the user over the cellular network.

The subject invention discloses a method for assigning and managing a line position for a walk-in government facility with a first come, first serve active line, the method comprising: opening a mobile software application on a mobile cellular device, wherein the software application comprises at least one search graphical user interface display screen with at least one first data entry field on the mobile cellular device to allow a user to search for a computer server of the walk-in government facility over a cellular network; searching for the government facility on the mobile device with the search graphical user interface display screen; displaying the government facility on at least one search results graphical user interface display screen with at least one selection button; selecting the computer server from the search results graphical user interface display screen with the selection button, wherein the computing server maintains a plurality of substantially real-time line positions of waiting patrons on a line position database and is configured to receive line reservation requests over the cellular network; requesting a substantially real-time line position over the cellular network from the computing server over the mobile cellular device, determining the next available substantially real-time line position from the plurality of substantially real-time line positions of waiting patrons; assigning the user to the next available substantially real-time line position; transmitting this line position to the mobile cellular device over the cellular network; and displaying the real-time substantially real-time line position on the mobile cellular device.

The subject invention discloses a method for assigning and managing a line position for a walk-in venue with a first come, first serve active line, the method comprising: opening a mobile software application on a mobile cellular device, wherein the software application comprises at least one search graphical user interface display screen with at least one first data entry field on the mobile cellular device to allow a user to search for a computer server of the walk-in venue over a cellular network; searching for the venue on the mobile device with the search graphical user interface display screen; displaying the venue on at least one search results graphical user interface display screen with at least one selection button; selecting the computer server from the search results graphical user interface display screen with the selection button, wherein the computing server maintains a plurality of substantially real-time line positions of waiting patrons on a line position database and is configured to receive line reservation requests over the cellular network; requesting a substantially real-time line position over the cellular network from the computing server over the mobile cellular device, determining the next available substantially real-time line position from the plurality of substantially real-time line positions of waiting patrons; assigning the user to the next available substantially real-time line position; transmitting this line position to the mobile cellular device over the cellular network; and displaying the real-time substantially real-time line position on the mobile cellular device.

The subject invention discloses a method for assigning and managing a line position for a walk-in service provider with a first come, first serve active line, the method comprising: opening a mobile software application on a mobile cellular device, wherein the software application comprises at least one search graphical user interface display screen with at least one first data entry field on the mobile cellular device to allow a user to search for a computer server of the walk-in service provider over a cellular network; searching for the service provider on the mobile device with the search graphical user interface display screen; displaying the service provider on at least one search results graphical user interface display screen with at least one selection button; selecting the computer server from the search results graphical user interface display screen with the selection button, wherein the computing server maintains a plurality of substantially real-time line positions of waiting patrons on a line position database and is configured to receive line reservation requests over the cellular network; requesting a substantially real-time line position over the cellular network from the computing server over the mobile cellular device, determining the next available substantially real-time line position from the plurality of substantially real-time line positions of waiting patrons; assigning the user to the next available substantially real-time line position; transmitting this line position to the mobile cellular device over the cellular network; and displaying the real-time substantially real-time line position on the mobile cellular device.

In embodiments of the subject invention, the user or patrons patron or user do not need to be at or near the physical location of service provider to obtain a line position.

In embodiments of the subject invention, the computer server may transmit “push notification” as e-mails, short messaging service (SMS), multimedia messaging service (MMS), or instant messaging (IM) to mobile cellular device. In embodiments of the subject invention, the system may configured to send “push notifications” of the user's real-time position in the active line by displaying the current user number being admitted or served at estimated wait-time intervals before the user is next in line.

In further embodiments of the subject invention, the system may allow a user to request a specific time for service, estimated by the system from the current waiting time.

In embodiments of the subject invention, the welcome screen may list several walk-in venue-specific rules or instructions.

In embodiments of the subject invention, the service provider may be exhibits, rides, shows, tables, seats, or open-spots within walk-in venues, resorts, museums, events, or amusement parks; government registration facilities, such as Motor Vehicle Registries, State taxation offices, IRS offices, post offices, Social Security Administration offices, and State college offices; or private service provider walk-in facilities such as cable companies, cell phone providers, or private shipping companies.

In embodiments of the subject invention, the point of service or access may be a permanent physical location, such as a government facility, a private business, an amusement park, a museum, a resort, a stadium, or a concert hall; or a temporary location for specific events, such as fairs and sporting events.

In embodiments of the subject invention, the mobile cellular device is a mobile phone, smart phone, computer tablet, a personal digital assistant

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of exemplary embodiments thereof, which description should be considered in conjunction with the accompanying drawings:

FIG. 1 illustrates an embodiment of the graphical user interface Search query screen of the system displayed on the mobile device.

FIG. 2 illustrates an embodiment of the graphical user interface Getting started screen of the system displayed on the mobile device.

FIG. 3 illustrates an embodiment of the graphical user interface My Profile screen of the system displayed on the mobile device.

FIG. 4 illustrates an embodiment of the graphical user interface Now Serving screen of the system displayed on the mobile device.

FIG. 5 illustrates an embodiment of the graphical user interface Now Serving screen of the system displayed on the mobile device.

FIG. 6 illustrates an embodiment of the graphical user interface Now Serving screen of the system displayed on the mobile device.

FIG. 7 illustrates an embodiment of the graphical user interface Now Serving screen of the system displayed on the mobile device.

FIG. 8 Illustrates an embodiment of the graphical user interface Now Serving screen of the system displayed on the mobile device.

FIG. 9 Illustrates an embodiment of the graphical user interface Now Serving screen of the system displayed on the mobile device.

FIG. 10 Illustrates an embodiment of the graphical user interface Now Serving screen of the system displayed on the mobile device.

### DETAILED DESCRIPTION OF EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

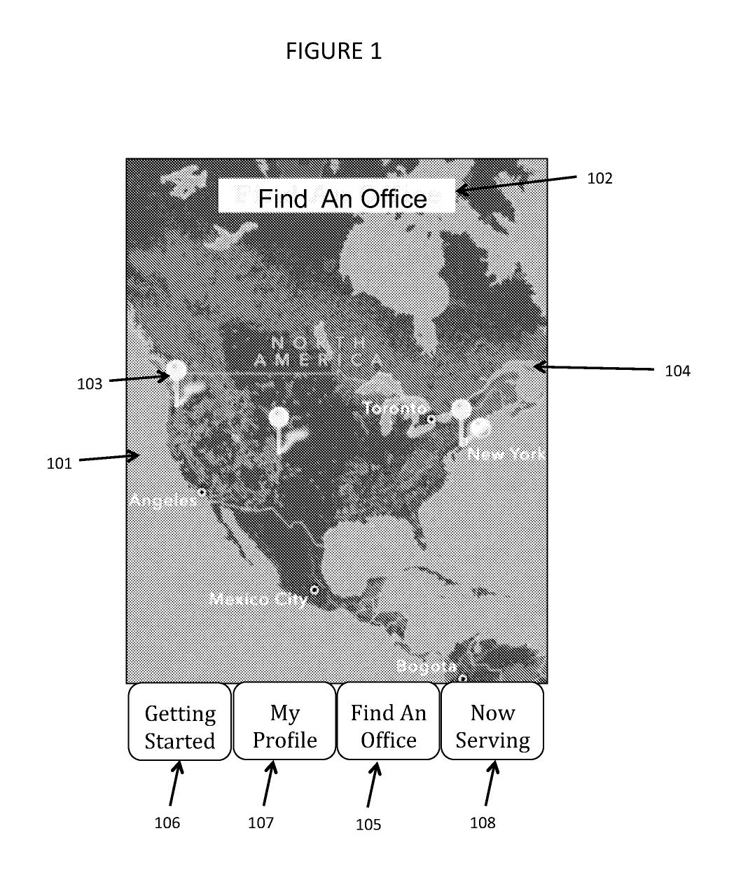

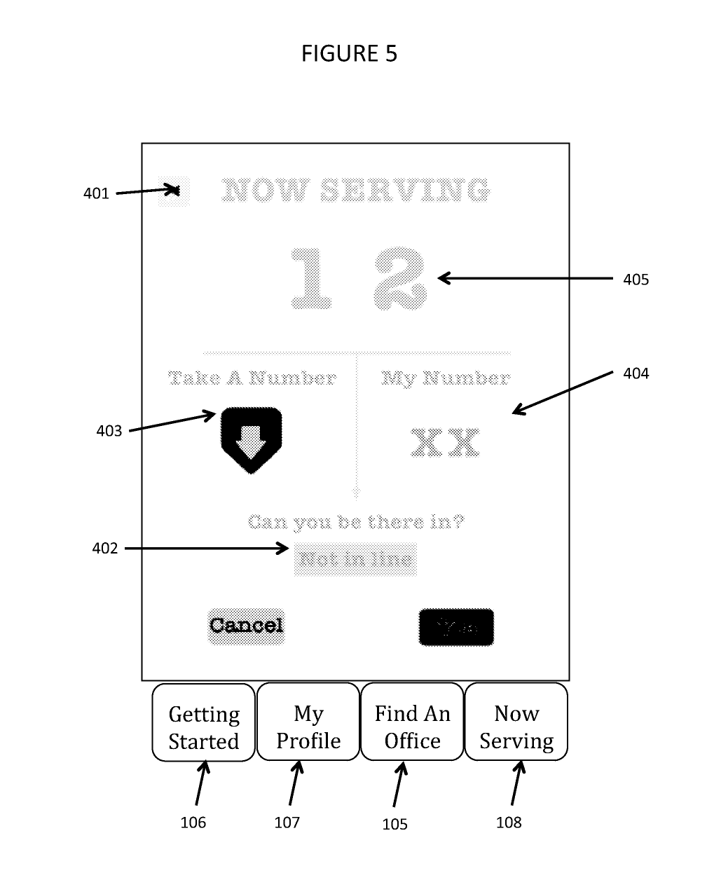

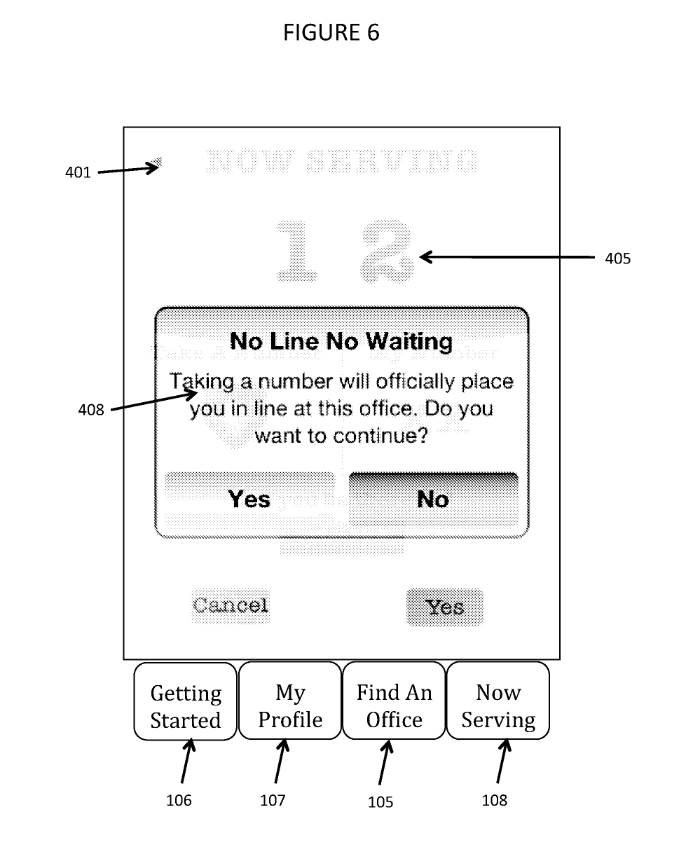

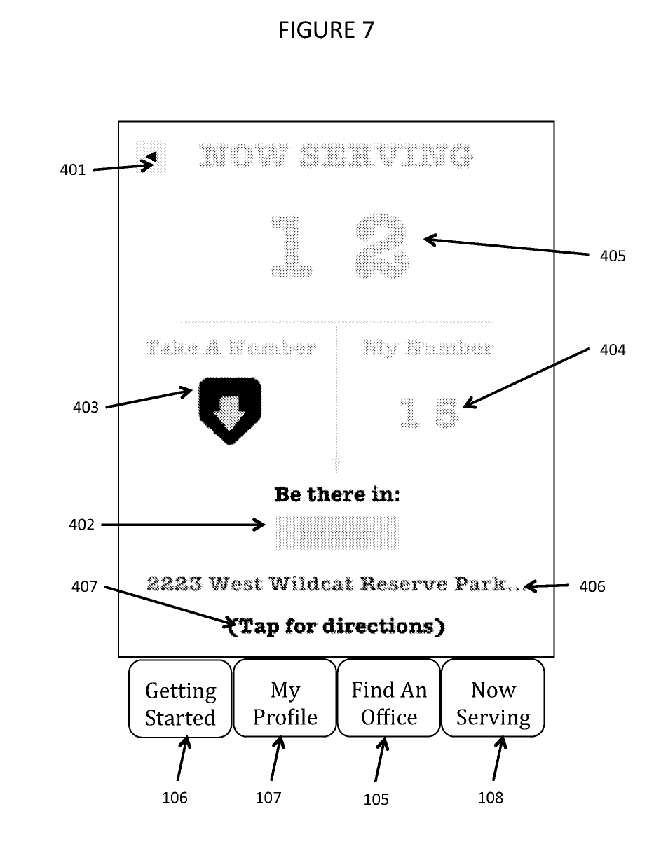

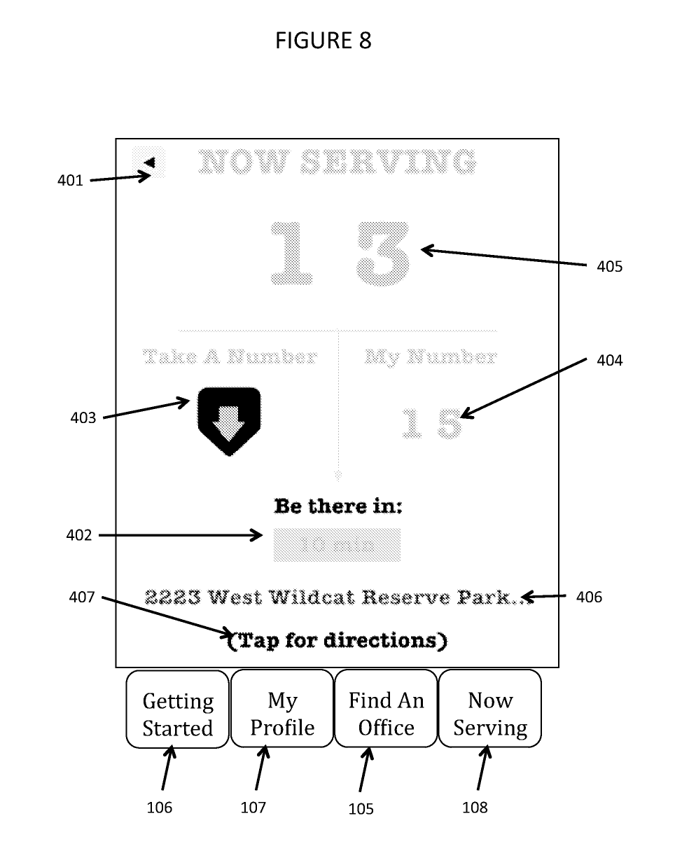

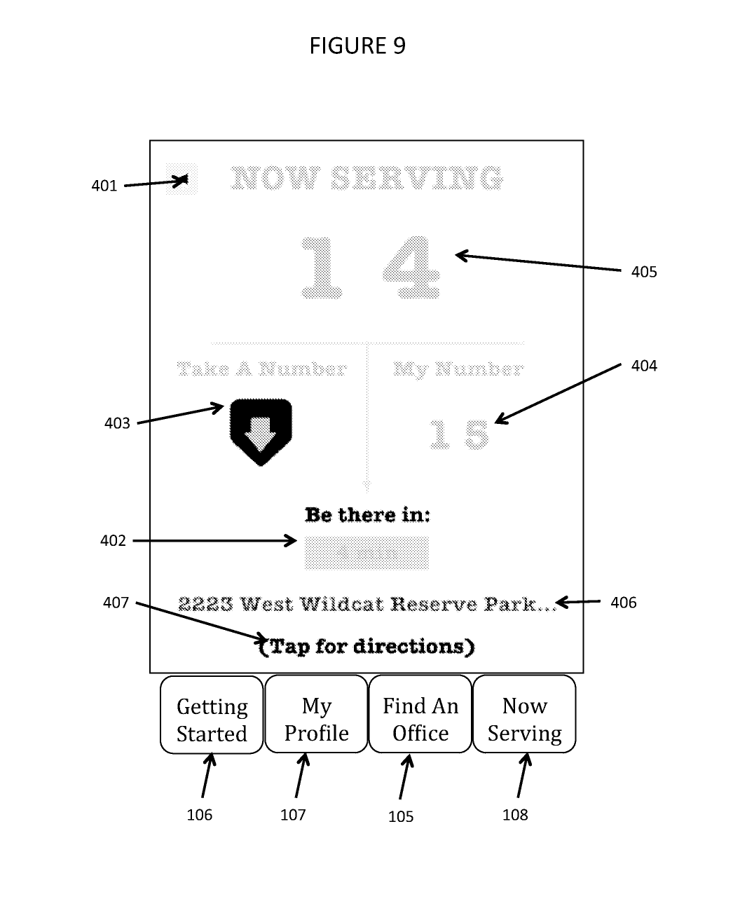

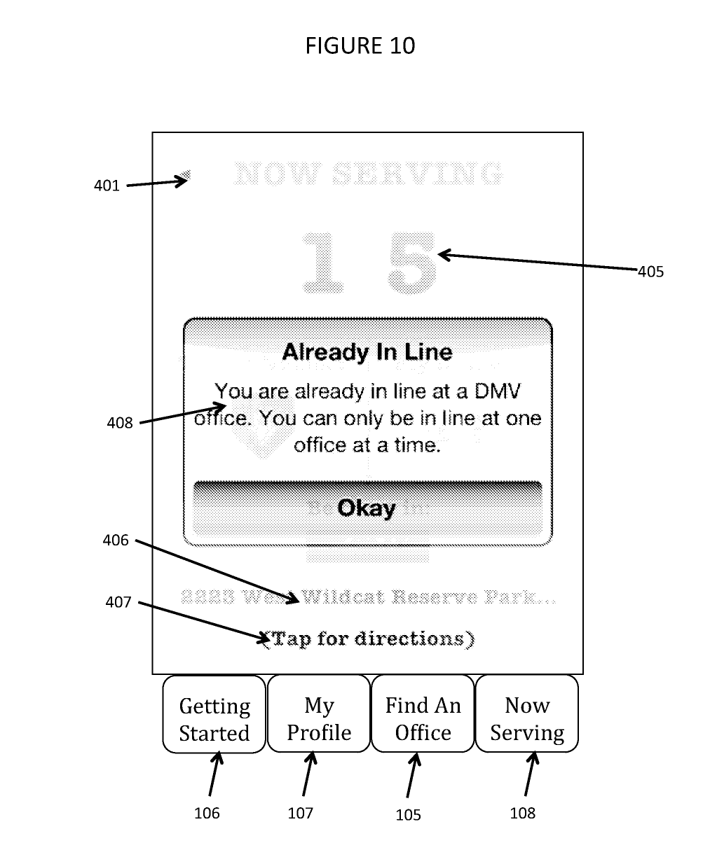

As illustrated in FIGS. 1-10, the subject invention is a method and system that manages active lines of customers waiting for admission to exhibits, rides, shows, tables, seats, or open-spots within walk-in venues, resorts, museums, events, or amusement parks; and manages active lines of users waiting for a live official at government registration facilities, such as Motor Vehicle Registries, State taxation offices, IRS offices, post offices, Social Security Administration offices, and State college offices; or private service provider walk-in facilities such as cable companies, cell phone providers, or private shipping companies. The subject invention is a method and system for determining and managing line positions at a point of access to a walk-in venue or a service provider. In embodiments of the subject invention, the point of service or access may be a permanent physical location, such as a government facility, a private business, an amusement park, a museum, a resort, a stadium, or a concert hall; or a temporary location for specific events, such as fairs and sporting events.

In embodiments of the subject invention, the use of the terms “user” or “customer” or “individual” is intended to refer to any person who may be using the system.

The system incorporates a software application for electronic mobile device, such as smartphones and computer tablets that manages the active lines of users. A user or customer installs the software application onto a mobile device from an on-line cloud network, and a wired connection known to those skilled in the art.

Once the software application is installed onto the mobile device, the user searches for the walk-in venue or service provider. One embodiment of the software application's first graphical user interface screen (GUI) to appear on the mobile device is a Search query screen 101, as illustrated in FIG. 1. The Search query screen 101 contains one or more data entry fields 102 to allow a user to input data into the software application to search for walk-in venues or service providers accessible by the system. In embodiments of the subject invention, the Search query screen 101 may have input data fields 102 for receiving data such as a class of service, type of venue, zip code, city, county, address, or State. The search results may be displayed by markers 103 on a map 104. In further embodiments of the subject invention, the system may automatically display local or regional walk-in venues or service providers accessible by the system with markers 103 on the map 104 upon software activation by the user.

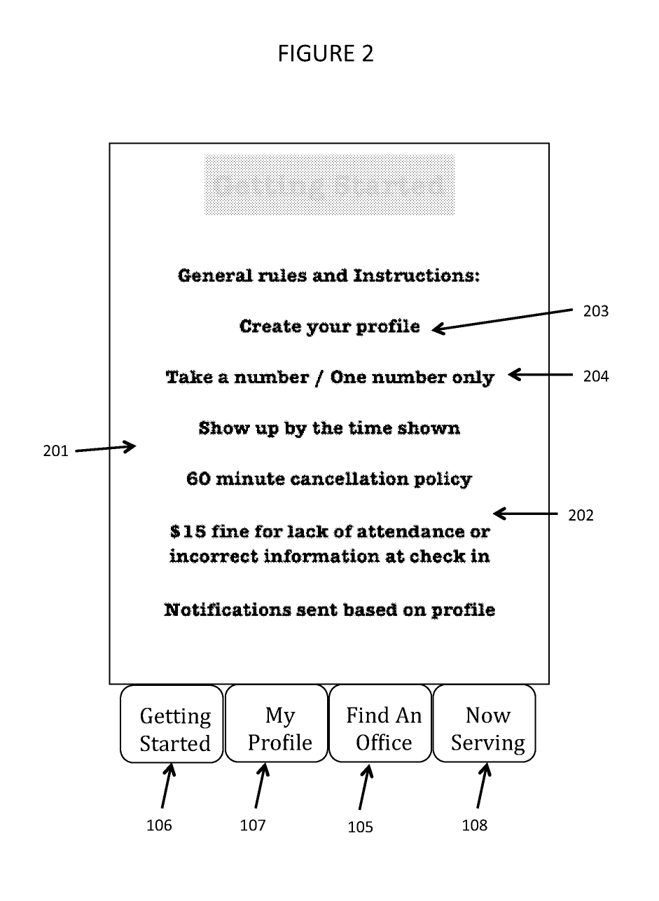

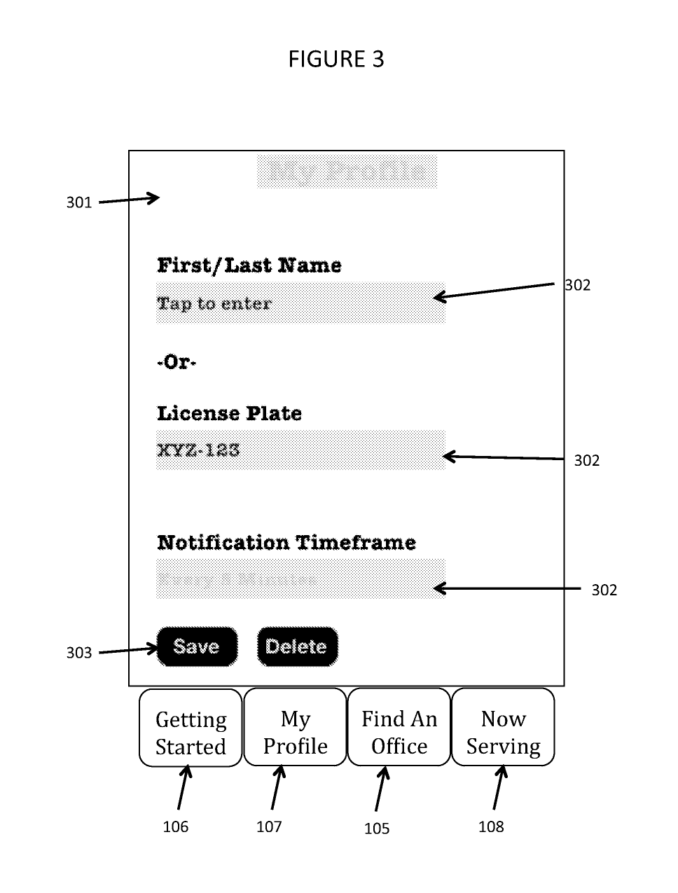

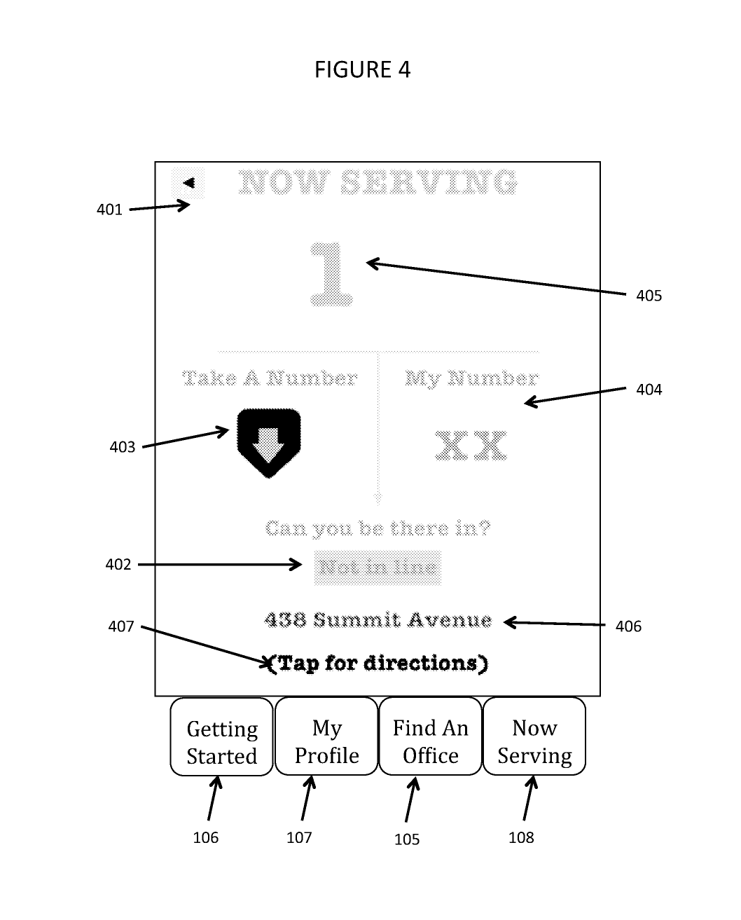

In embodiments of the subject invention, all graphical user interface screens (GUI) of the mobile software application may display a “FIND AN OFFICE” button 105 to access the Search query screen 101; a “GETTING STARTED” button 106 to access the Getting Started GUI screen 201, illustrated in FIG. 2, a “MY PROFILE” button 107 to access the My Profile GUI screen 301, illustrated in FIG. 3; and a “NOW SERVING” button 108 to access the Now Serving GUI screen 401, illustrated in FIGS. 4-10.

Once the user selects a walk-in venue from the Search query screen 101, the software application on the mobile device wirelessly accesses a host server maintained by each walk-in venue. The system provides each walk-in venue and service provider with a host server that contains local, regional and national databases of lines and wait times for each location. Each host server also contains means for transferring data from these databases to mobile devices accessing the system.

The walk-in venue, through the host server, transmits a Getting Started GUI screen 201 to the mobile device, an embodiment of the Getting Started GUI screen 201 is illustrated in FIG. 2. In embodiments of the subject invention, the Getting Started screen 201 may list several walk-in venue-specific rules or instructions 202, such as reminding the patron to show up by the time shown on the Now Serving screen 401, a time period cancellation policy, a fine for failing to show up, or providing incorrect profile information on the My Profile screen 301.

On the Getting Started screen 201, the user may select the “Create your profile” link 203 which accesses the My Profile screen 301 illustrated in FIG. 3. The user may also select the “Take a number/One number only” link 204 to access the Now Serving screen 401 illustrated in FIGS. 4-10.

The My Profile screen 301 contains one or more data entry fields 302 to allow a user to input data into the software application to upload the user's information into the walk-in venue's host server databases with a Save button 303. In embodiments of the subject invention, the My Profile screen 301 may have input data fields 302 for uploading personal data such as the user's name, address, driver's license number, birth date, social security number, or the user's physical description. In another embodiment of the subject invention, the My Profile screen 301 may allow digital images of the user using a mobile device's camera to be uploaded into the walk-in venue's host server. In a further embodiment of the subject invention, the My Profile screen 301 may allow other personal information to be uploaded to the walk-in venue host server, including, but not limited to: a user retinal scan, a user fingerprint, a user thumbprint, a user palm print, a user voice sample, or a user recognized facial pattern.

Once the user's profile information has been uploaded by the mobile device and accepted by the host walk-in venue server, the host server, transmits the Now Serving screen 401 to the mobile device. Embodiments of the Now Serving screen 401 are illustrated in FIGS. 4-10. The Now Serving screen 401 provides a real-time estimated wait time 402 for the user before he or she will be the next for admission or service in the active line. The Now Serving screen 401 provides a button 403 allowing a user to access a real-time electronic ticket. Once the user presses button 403, the system will provide the user with a line number 404 representing the user's real-time position in an active line for the walk-in venue or service provider. The Now Serving screen 401 will constantly update the user's real-time position 404 in the active line by displaying the current user number 405 being admitted or served. The Now Serving screen 401 will provide an address 406 for the walk-in venue and a link 407 to access on-line directions.

In embodiments of the subject invention, the user may leave the Now Serving screen 401. The host server will constantly update the user's real-time position in the active line with a continual “push notification” 408 on the mobile device. In embodiments of the subject invention, the “push notification” may be e-mails, short messaging service (SMS), multimedia messaging service (MMS), or instant messaging (IM) to mobile device. These “push notifications” will allow users to view their own “ticket number” against the “Now Serving” number for a better idea of their position in line. The system will constantly keep a running average of the amount of time between increments of the “Now Serving” table. The user can manage their time to show up as needed, avoiding the waiting time in the active line. In embodiments of the subject invention, the system may configured to send “push notifications” of the user's real-time position 404 in the active line by displaying the current user number 405 being admitted or served at estimated wait-time intervals before the user is next in line. For example, the system may send a “push notification” to the user when the user's real-time position 404 is estimated to be 1 hour, 30 minutes, 15 minutes, or 5 minutes from being the next user served in line.

In further embodiments of the subject invention, the Now Serving screen 401 may allow a user to request a specific time for service, estimated by the system from the current waiting time. In other embodiments of the subject invention, the Now Serving screen 401 may allow a user to cancel the electronic ticket.

The system provides personnel working at the walk-in venue or service provider with electronic means of maintaining and accessing the databases on the host server identifying the individuals holding an electronic ticket for the line. These databases will store user profile records, their current numbers in line, and current dates. The system achieves these objectives by providing a means for receiving data from the host server on a plurality of walk-in venue workstations at the walk-in venue; a means for organizing all the download data from the local, regional and national databases; a means for running specific search queries from the plurality of walk-in venue workstations on the databases; and a means for displaying the search query results on the walk-in venue workstations. In embodiments of the subject invention, all updates to the databases are in real time and synchronized between local, regional and national databases.

In further embodiments of the subject invention, the workstation may be a personal computer or a local server with a computer display connected to the Internet through a wired or wireless connection. In another embodiment of the subject invention, the workstation may be a mobile device that is connected to the Internet through a wired or wireless connection.

In embodiments of the subject invention, walk-in venues and service providers may establish a registration system for recurring users of the system. For example, all recurring user may submit their profile to the walk-in venue or service provider in exchange for a walk-in venue password or PIN.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A mobile software application executable on a mobile cellular device for assigning and managing a line position for a walk-in service provider with a first come, first serve active line, the mobile software application comprising: at least one first graphical user interface screen with at least one first data entry field to allow a user to search for a computer server of the walk-in service provider over a cellular network, wherein the user selects the computer server, further wherein the computing server maintains a plurality of substantially real-time line positions of waiting patrons on a line position database and is configured to receive line reservation requests over the cellular network; at least one second graphical user interface screen with at least one second data entry field to allow a user to request a substantially real-time line position over the cellular network from the computing server, wherein the computer server determines the next available substantially real-time line position from the plurality of substantially real-time line positions of waiting patrons, assigns the user to the next available substantially real-time line position to the user, and transmits this line position to the mobile cellular device over the cellular network.

2. A system for assigning and managing a line position for a walk-in service provider with a first come, first serve active line, the system comprising: a computing server comprising executable software; a line position database on the computing server, wherein the computing server maintains a plurality of substantially real-time line positions of waiting patrons on the database, further wherein the computer server is configured to receive line reservation requests over a cellular network; a software application executable on a mobile cellular device, wherein a user requests a substantially real-time line position over the cellular network from the computing server, further wherein the computer server determines the next available substantially real-time line position from the plurality of substantially real-time line positions of waiting patrons, assigns the next available substantially real-time line position to the user, and transmits this position to the user over the cellular network.

3. The software application of claim 1, wherein the service provider is selected from the group consisting of exhibits, rides, shows, tables, seats, venues, resorts, museums, events, amusement parks, government registration facilities, Motor Vehicle Registries, State taxation offices, IRS offices, post offices, Social Security Administration offices, and State college offices.

4. The software application of claim 1, wherein the service provider comprises a permanent physical location.

5. The software application of claim 1, wherein the service provider comprises such a temporary location for specific events.

6. The software application of claim 1, wherein the mobile cellular device is a tablet.
